(19) United States
(12) Patent Application Publication
(10) Pub. No.: US 2026/0175846 A1
(43) Pub. Date: Jun. 25, 2026

(54) MOTION SICKNESS SUPPRESSION DEVICE, MOTION SICKNESS SUPPRESSION METHOD, AND STORAGE MEDIUM

(71) Applicant: Sony Honda Mobility Inc., Tokyo (JP)

(72) Inventor: Toshihiro Hirao, Tokyo (JP)

(73) Assignee: Sony Honda Mobility Inc., Tokyo (JP)

(21) Appl. No.: 19/077,746

(22) Filed: Mar. 12, 2025

(30) Foreign Application Priority Data
Dec. 25, 2024 (JP) 2024-229045

(51) Int. Cl. B60W 40/08; B60K 35/22; B60K 35/81; G06F 3/01

(52) U.S. Cl. CPC B60W 40/08; B60K 35/22; B60K 35/81; G06F 3/011; B60W 2420/403

(57) ABSTRACT

A motion sickness suppression device includes: a sickness determination unit which determines a degree of motion sickness of a passenger viewing a viewing target displayed on a display device in a conveyance; and a suppression control unit which switches a mode of suppression display for suppressing motion sickness according to the determined degree of motion sickness and displays the mode on the display device.

### CROSS-REFERENCE TO RELATED APPLICATION

Priority is claimed on Japanese Patent Application No. 2024-229045 filed on Dec. 25, 2024, the content of which is incorporated herein by reference.

### BACKGROUND OF THE INVENTION

### Field of the Invention

The present invention relates to a motion sickness suppression device, a motion sickness suppression method, and a storage medium.

### Description of Related Art

Conventionally, various methods have been proposed for suppressing motion sickness in passengers of vehicles. For example, there is known a method for suppressing motion sickness by displaying an image of the outside of a vehicle on a part of a screen when a passenger is viewing the content such as a television image using a display device mounted on the vehicle, or by changing the display content according to the acceleration of the vehicle (for example, see Patent Document 1 below). In addition, there is also known a method for suppressing motion sickness in passengers by displaying a horizontal line on a display screen of a smartphone used in a vehicle (for example, see Non-Patent Document 1 below).
[Patent Document 1] PCT International Publication No. WO 2006/008994
[Non-Patent Document 1] “Kine Stop: Goodbye travel sickness—Google Play app”, [online], [searched on Oct. 15, 2024], Internet <URL: https://play.google.com/store/apps/details?id=com.urbandroid.kinestop&hl=ja>

### SUMMARY OF THE INVENTION

Incidentally, the degree of motion sickness varies according to the behavior of the vehicle and individual differences in resistance to motion sickness. In the conventional methods, since the degree of motion sickness experienced by each passenger is not considered, motion sickness suppression was not always performed properly. For example, excessive display control may suppress motion sickness in passengers with slight motion sickness, which may interfere with viewing content. On the other hand, for passengers with severe motion sickness, the display control for suppressing motion sickness may not be sufficient, and the suppression effect may not be fully achieved.

An aspect of the present invention has been made in view of such circumstances, and an object thereof is to provide a motion sickness suppression device, a motion sickness suppression method, and a storage medium capable of achieving both a good viewing experience and motion sickness suppression while riding in a conveyance by switching the mode of suppression display according to the degree of motion sickness of the passenger.

In order to solve the above-described problems and achieve the above-described object, the present invention employs the following aspects.

(1) A motion sickness suppression device according to an aspect of the present invention includes: a sickness determination unit which determines a degree of motion sickness of a passenger viewing a viewing target displayed on a display device in a conveyance; and a suppression control unit which switches a mode of suppression display for suppressing motion sickness according to the determined degree of motion sickness and displays the mode on the display device.

(2) In Aspect (1), the sickness determination unit may determine the degree of motion sickness on the basis of a passenger state.

(3) In Aspect (2), the sickness determination unit may determine the degree of motion sickness on the basis of vital data of the passenger detected by a sensor.

(4) In Aspect (2), the sickness determination unit may determine the degree of motion sickness on the basis of image data of the passenger captured by an imaging device.

(5) In Aspect (1), the sickness determination unit may determine the degree of motion sickness on the basis of an input instruction by the passenger.

(6) In Aspect (1), the sickness determination unit may determine the degree of motion sickness on the basis of behavior of the conveyance within a predetermined time period in the past or a location of the conveyance.

(7) In Aspects (1) to (6), the sickness determination unit may determine the degree of motion sickness on the basis of information on resistance of the passenger to the motion sickness.

(8) In Aspect (7), the motion sickness suppression device may further include: a resistance information management unit which updates the resistance information on the basis of a change history of the degree of motion sickness changed according to an input instruction by the passenger.

(9) In Aspects (1) to (6), the suppression display may be a horizontal line.

(10) In Aspects (1) to (6), the suppression control unit may control the display of the display device so that the suppression display becomes emphasized as the determined degree of motion sickness becomes worse.

(11) In Aspect (10), the suppression control unit may control the display of the display device so that a viewing target display area in the display device is reduced and a display area of the suppression display is enlarged as the determined degree of motion sickness becomes worse.

(12) In Aspect (10), the suppression control unit may control the display of the display device so that a contrast of a display of the viewing target in the display device decreases as the determined degree of motion sickness becomes worse.

(13) A motion sickness suppression method according to an aspect of the present invention causes a computer to: determine a degree of motion sickness of a passenger viewing a viewing target displayed on a display device in a conveyance; and switch a mode of suppression display for suppressing motion sickness according to the determined degree of motion sickness and display the mode on the display device.

(14) A storage medium according to an aspect of the present invention stores a program causing a computer to: determine a degree of motion sickness of a passenger viewing a viewing target displayed on a display device in a conveyance; and switch a mode of suppression display for suppressing motion sickness according to the determined degree of motion sickness and display the mode on the display device.

According to Aspects (1) to (14), it is possible to achieve both a good viewing experience and motion sickness suppression while riding in the conveyance by switching the mode of the suppression display according to the degree of motion sickness of the passenger. Accordingly, priority can be given to the viewing experience when motion sickness is slight, or to improvement of the passenger's motion sickness when motion sickness becomes worse.

According to Aspects (2) to (4), it is possible to determine the degree of motion sickness according to the passenger state and to automatically switch the mode of suppression display in the display device.

According to Aspect (5), in response to an input instruction from the passenger (such as touch panel operation or voice recognition), the display mode can be switched to a suppression display mode in accordance with the passenger's request.

According to Aspect (6), it is possible to take preventive measures against motion sickness in a safe manner before the passengers start to feel motion sickness by switching the display suppression mode according to the behavior of the conveyance or the location of the conveyance. Once motion sickness occurs, it is difficult to cure the motion sickness, so these preventative and safety measures against motion sickness are effective.

According to Aspects (7) and (8), it is possible to implement more effective measures against motion sickness by taking into account the passenger's resistance to motion sickness.

### BRIEF DESCRIPTION OF THE DRAWINGS

FIG. 1 is a diagram showing an example of a configuration of a motion sickness suppression system S of an embodiment.

FIG. 2 is a diagram showing the interior of a vehicle M of the embodiment.

FIG. 3A is a diagram illustrating the display content of a display 10 when suppression control of the embodiment is not performed.

FIG. 3B is a diagram illustrating the display content (depth 1, horizontal) of the display 10 when suppression control of the embodiment is performed.

FIG. 3C is a diagram illustrating the display content (depth 1, inclined downward and leftward) of the display 10 when suppression control of the embodiment is performed.

FIG. 3D is a diagram illustrating the display content (depth 1, inclined downward and rightward) of the display 10 when suppression control of the embodiment is performed.

FIG. 3E is a diagram illustrating the display content (depth 2, inclined downward and leftward) of the display 10 when suppression control of the embodiment is performed.

FIG. 3F is a diagram illustrating the display content (depth 3, inclined downward and leftward) of the display 10 when suppression control of the embodiment is performed.

FIG. 3G is a diagram illustrating the display content (depth 4) of the display 10 when suppression control of the embodiment is performed.

FIG. 4 is a flowchart showing an example of a flow of a process of a motion sickness suppression device 1 of the embodiment.

FIG. 5 is a flowchart showing an example of a flow of a process of suppression control according to depth of the embodiment.

FIG. 6 is a flowchart showing an example of a flow of a process of detecting a passenger state and determining a depth of the embodiment.

FIG. 7 is a diagram showing passenger resistance information (resistance map of passenger P) of a passenger state associated with the passenger P of the embodiment.

FIG. 8 is a diagram showing standard resistance information (standard resistance map) of a passenger state of the embodiment.

FIG. 9 is a flowchart showing an example of a flow of a process of detecting a vehicle state and determining a depth of the embodiment.

FIG. 10 is a diagram showing passenger resistance information (resistance map of passenger P) of a vehicle state associated with the passenger P of the embodiment.

FIG. 11 is a diagram showing standard resistance information (standard resistance map) related to a vehicle state of the embodiment.

FIG. 12 is a diagram showing passenger resistance information according to a vehicle position associated with the passenger P of the embodiment.

FIG. 13 is a diagram showing standard resistance information according to a vehicle position of the embodiment.

### DETAILED DESCRIPTION OF THE INVENTION

Hereinafter, an embodiment of a motion sickness suppression device, a motion sickness suppression method, and a storage medium of the present invention will be described with reference to the drawings. The motion sickness suppression device of the embodiment can achieve both a good viewing experience and motion sickness suppression while riding in a conveyance by switching the mode of suppression display displayed on a display device to suppress (ameliorate) motion sickness according to the degree of motion sickness of the person (passenger) riding in the conveyance. The conveyance is any moving body on which a person can ride, such as a four-wheeled vehicle, a ship, or an airplane. Hereinafter, an example will be described in which the conveyance is a vehicle.

### System Configuration

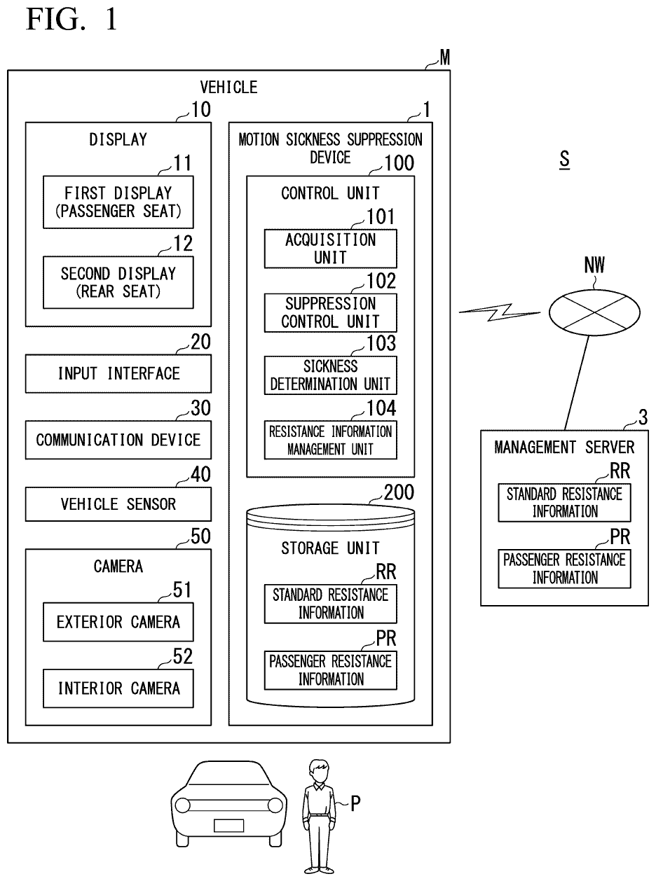

FIG. 1 is a diagram showing an example of a configuration of a motion sickness suppression system S of the embodiment. The motion sickness suppression system S includes, for example, a motion sickness suppression device 1 mounted on a vehicle M and a management server 3. The motion sickness suppression device 1 and the management server 3 are connected to each other so as to be able to communicate with each other via a wireless or wired communication network NW. The communication network NW includes, for example, a cellular network, a Wi-Fi network, an Internet, a local area network (LAN), and a wide area network (WAN).

“Conveyance motion sickness” refers to a malfunction of a brain caused by conflicting information from organs of balance due to the shaking and acceleration of a moving conveyance. Symptoms caused by motion sickness include, for example, nausea, dizziness, sweating, and hyperventilation. The degree of motion sickness is expressed, for example, by a numerical value (depth). The numerical value of the depth is set to increase as the degree of motion sickness becomes higher (becomes severe). Furthermore, the degree of motion sickness may be expressed by levels such as slight, medium, and severe.

### Vehicle M

The vehicle M can accommodate one or more passengers P. The drive source of the vehicle M is an internal combustion engine such as a diesel engine or a gasoline engine, an electric motor, or a combination of these. The electric motor is operated using power generated by a generator connected to the internal combustion engine, or using power discharged from a battery (storage battery) such as a secondary battery or a fuel cell. In addition to various mechanisms for driving, the vehicle M is equipped with, for example, a display 10, an input interface 20, a communication device 30, a vehicle sensor 40, a camera 50, and the like.

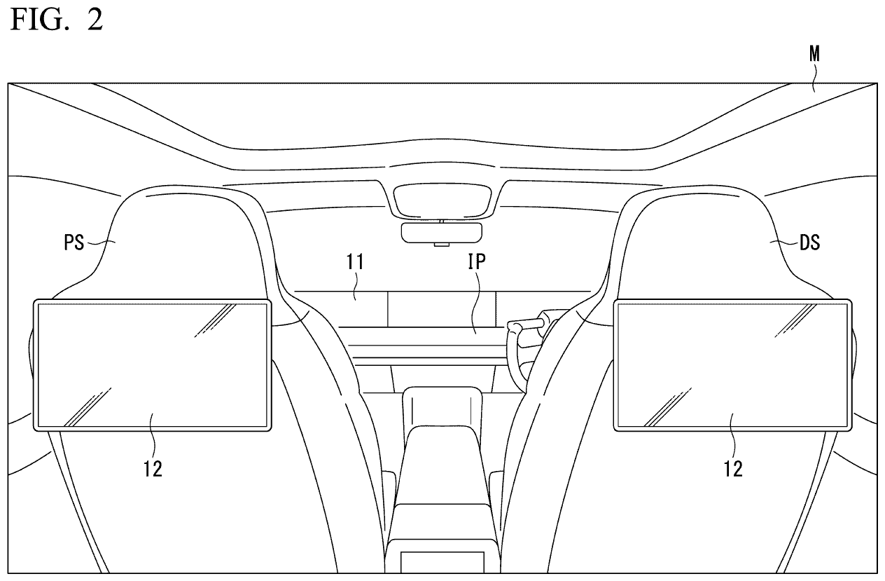

FIG. 2 is a diagram showing the interior of the vehicle M of the embodiment. A plurality of displays 10 are provided in the interior of the vehicle M. The plurality of displays 10 include, for example, a first display 11 and a second display 12. The first display 11 is, for example, located in front of a passenger seat PS and provided on an instrument panel IP. The second display 12 is provided, for example, on the back of a driver seat DS and the passenger seat PS. Furthermore, the plurality of displays 10 may include, for example, a display located in front of the driver seat DS and provided on the instrument panel IP, and a portable display such as a smartphone or tablet used inside the vehicle M. The display 10 is an example of a “display device.”

Returning to FIG. 1, the input interface 20 receives various input operations by the passenger P of the vehicle M. The input operation (operation signal) received by the input interface 20 is output to the motion sickness suppression device 1. The input interface 20 includes, for example, a touch panel, a switch, a key, a microphone, and the like. When the display 10 is a touch panel, the function of the input interface 20 may be incorporated into the display 10.

The communication device 30 communicates with external devices such as the management server 3 via the communication network NW. Various information acquired by the communication device 30 is output to the motion sickness suppression device 1.

The vehicle sensor 40 detects various information related to the state of the vehicle M. The vehicle sensor 40 includes a vehicle speed sensor that detects the speed of the vehicle M, an acceleration sensor that detects acceleration, a sensor (for example, an acceleration sensor) that detects a roll angle (for example, a rotation angle around an axis in the front and rear direction of the vehicle passing through the center of gravity of the vehicle M), a yaw rate sensor that detects a yaw rate (for example, a rotation angular velocity around a vertical axis passing through the center of gravity of the vehicle M), a direction sensor that detects the orientation of the vehicle M, and a position sensor that detects the position of the vehicle M. The position sensor acquires position information (longitude and latitude information) from, for example, a global positioning system (GPS) device. In addition, the vehicle sensor 40 may include an accelerator opening sensor attached to an accelerator pedal that receives an acceleration instruction, a brake depression sensor attached to a brake pedal that receives a braking instruction, and the like. The results detected by the vehicle sensor 40 are output to the motion sickness suppression device 1.

The camera 50 includes, for example, an exterior camera 51 that captures an image outside the vehicle M and an interior camera 52 that captures an image inside the vehicle M. The camera 50 is a digital camera that uses a solid-state image sensor such as a charge coupled device (CCD) or a complementary metal oxide semiconductor (CMOS). The exterior camera 51 is attached to an arbitrary position outside the vehicle M. The interior camera 52 is attached to an arbitrary position inside the vehicle M. The interior camera 52 may be an RGB camera.

### Conveyance Motion Sickness Suppression Device

The motion sickness suppression device 1 provides a function for suppressing motion sickness to the passenger P in the vehicle M. The motion sickness suppression device 1 includes, for example, a control unit 100 and a storage unit 200. The control unit 100 includes, for example, an acquisition unit 101, a suppression control unit 102, a sickness determination unit 103, and a resistance information management unit 104.

Each of the functional units of the control unit 100 is realized by a computer processor, such as a central processing unit (CPU) or an electronic control unit (ECU), executing a program (software). Each of the functional units of the control unit 100 may be realized by hardware (circuit units) such as a large scale integration (LSI), an application specific integrated circuit (ASIC), a field-programmable gate array (FPGA), or a graphics processing unit (GPU), or may be realized by a combination of software and hardware. Each of the functions of the control unit 100 may be realized by a single device, or may be a system in which multiple devices (for example, management server 3) connected via the communication network NW operate in cooperation with each other.

The acquisition unit 101 acquires various information used for motion sickness suppression control. For example, the acquisition unit 101 acquires instructions from the passenger P input via the input interface 20, various information received from the management server 3, various detection values detected by the vehicle sensor 40, images captured by the camera 50, and the like.

The suppression control unit 102 switches the mode of suppression display for suppressing motion sickness according to the degree of motion sickness of the passenger P and displays the mode on the display 10. The suppression control unit 102 controls the display on the display 10 so that the suppression display becomes emphasized as the degree of motion sickness becomes worse. For example, the suppression control unit 102 controls the display of the display 10 so that the display area of the viewing target on the display 10 is reduced and the display area of the suppression display is enlarged as the degree of motion sickness becomes worse. Further, the suppression control unit 102 controls the display of the display 10 so that the contrast of the display of the target viewed on the display 10 decreases as the degree of motion sickness becomes worse. The process of the suppression control unit 102 will be described in detail later.

The sickness determination unit 103 determines the degree of motion sickness of the passenger P who is viewing the viewing target displayed on the display 10 in the vehicle M. The sickness determination unit 103 determines the degree of motion sickness of the passenger P on the basis of an input instruction by the passenger P, the state of the passenger P, the behavior of the vehicle M within a predetermined time period in the past, or the location of the vehicle M. The state of the passenger P is determined on the basis of vital data (heart rate, blood pressure, body temperature, and the like) detected by a sensor such as a wearable device worn by the passenger P. Alternatively, the state of the passenger P is determined on the basis of image data of the passenger P captured by an imaging device such as the interior camera 52. Further, the sickness determination unit 103 may determine the degree of motion sickness of the passenger P on the basis of information on the resistance to motion sickness. Further, the sickness determination unit 103 may determine the degree of motion sickness on the basis of speech information (such as the number of speeches) of the passenger P collected by the microphone. The process of the sickness determination unit 103 will be described in detail later.

The resistance information management unit 104 updates the resistance information of the passenger P to motion sickness on the basis of the change history of the degree of motion sickness changed in response to the input instruction by the passenger P. The process of the resistance information management unit 104 will be described in detail later.

The storage unit 200 stores various information necessary for controlling the vehicle M. The storage unit 200 stores, for example, standard resistance information RR, passenger resistance information PR, and the like acquired from the management server 3. The standard resistance information RR is information on the motion sickness resistance of a standard passenger. The passenger resistance information PR is information related to the motion sickness resistance of each passenger. The resistance information includes resistance information related to the passenger state and resistance information related to the vehicle state. The storage unit 200 is realized by an electrically erasable programmable read only memory (EEPROM), a read only memory (ROM), a random access memory (RAM), and the like. At least a part of the information included in the storage unit 200 may be stored in an external device capable of communicating with the vehicle M.

### Management Server

The management server 3 comprehensively manages various information used in the suppression control performed by the motion sickness suppression device 1. The management server 3 manages, for example, standard resistance information RR commonly used among vehicles and passenger resistance information PR for each passenger P (for each vehicle M). The management server 3 functions as a cloud server.

### Suppression Control for Suppressing Motion Sickness

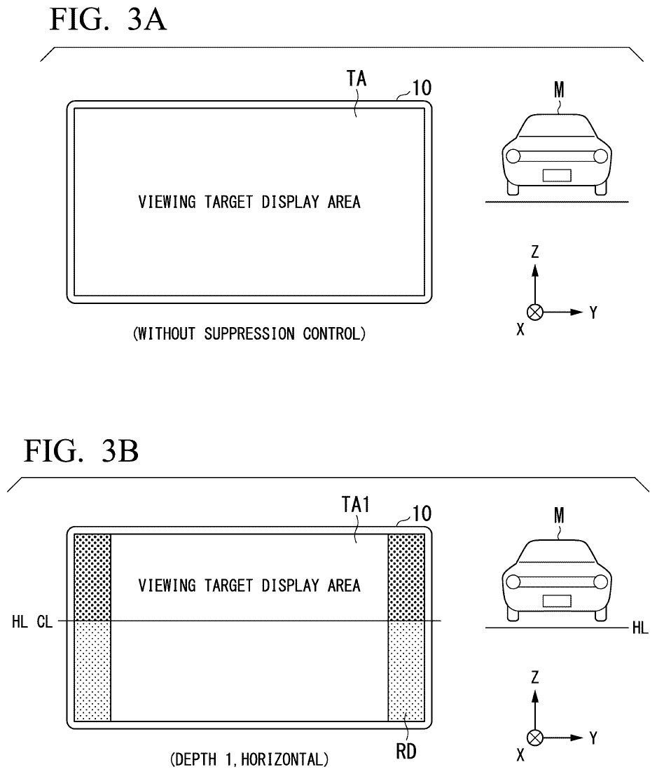

The motion sickness suppression device 1 displays a suppression display on the display 10 as suppression control (suppression means) for suppressing motion sickness. In the suppression control, the mode (pattern) of the suppression display (for example, the horizontal line) is changed in stages according to the degree (depth) of the motion sickness of the passenger P. FIGS. 3A to 3G are diagrams illustrating an overview of depth-dependent suppression display of the embodiment.

### No Suppression Control

FIG. 3A is a diagram illustrating the display content of the display 10 when suppression control is not performed. FIG. 3A shows an example in which the vehicle M with the passenger P is moving straight in the X-axis direction. In this case, the entire screen of the display 10 becomes a viewing target display area TA. The passenger P can view the viewing target (content such as a television image) displayed in this viewing target display area TA.

### Suppression Control: Depth 1, Horizontal>

FIG. 3B is a diagram showing the display content of the display 10 when suppression display is performed (depth 1 and horizontal). FIG. 3B shows an example in which the vehicle M with the passenger P determined to be at depth 1 is moving straight along a horizontal road (horizon line HL) in the X-axis direction. A viewing target display area TA1 in this case is reduced while maintaining an aspect ratio compared to the viewing target display area TA in the case without suppression control. Further, in the entire screen of the display 10, a suppression display RD is displayed in the area other than the viewing target display area TA1 (the remaining areas on both sides). The suppression display RD is, for example, a horizontal line HL. In this case, since the vehicle M is kept horizontal, the horizontal line HL is displayed horizontally in the left and right direction of the display 10. For example, the horizontal line HL is displayed at the position of the center line CL in the vertical direction of the display 10. Furthermore, the suppression display RD is not limited to the horizontal line HL, but may be anything that indicates a horizontal position. For example, the suppression display RD may be a marker or other transparent image displayed in the remaining areas on both sides of the viewing target display area TA1.

### Suppression Control: Depth 1, Inclined Downward and Leftward

FIG. 3C is a diagram showing the display content of the display 10 when suppression control is performed (depth 1, inclined downward and leftward). FIG. 3C shows an example in which the vehicle M with the passenger P determined to be at depth 1 is moving straight in the X-axis direction on a road that is inclined downward and leftward (a road that is tiled at an angle θ1 counterclockwise around the X-axis with respect to the horizontal line HL). As in FIG. 3B, the viewing target display area TA1 in this case is reduced while maintaining the aspect ratio compared to the viewing target display area TA in the case without suppression control. Further, in the entire screen of the display 10, the suppression display RD is displayed in the area other than the viewing target display area TA1 (the remaining areas on both sides). In this case, since the vehicle M is inclined downward and leftward, the horizontal line HL is displayed on the display 10 downward and rightward. For example, the horizontal line HL is displayed so as to be inclined at an angle θ1 clockwise around the X-axis with respect to the center line CL.

### Suppression Control: Depth 1, Inclined Downward and Rightward

FIG. 3D is a diagram showing the display content of the display 10 when suppression control is performed (depth 1, inclined downward and rightward). FIG. 3D shows an example in which the vehicle M with the passenger P determined to be at depth 1 is moving straight in the X-axis direction on a road that is inclined downward and rightward (a road that is tiled at an angle θ2 clockwise around the X-axis with respect to the horizontal line HL). As in FIG. 3B, the viewing target display area TA1 in this case is reduced while maintaining the aspect ratio compared to the viewing target display area TA in the case without suppression display. Further, in the entire screen of the display 10, the suppression display RD is displayed in the area other than the viewing target display area TA1 (the remaining areas on both sides). In this case, since the vehicle M is inclined downward and rightward, the horizontal line HL is displayed downward and leftward on the display 10. For example, the horizontal line HL is displayed to be inclined at an angle θ2 counterclockwise around the X-axis with respect to the center line CL.

### Suppression Control: Depth 2, Inclined Downward and Leftward

FIG. 3E is a diagram showing the display content of the display 10 when suppression control is performed (depth 2, inclined downward and leftward). FIG. 3E shows an example in which the vehicle M with the passenger P determined to be at depth 2 is moving straight in the X-axis direction on a road that is inclined downward and leftward (a road that is inclined at an angle θ1 counterclockwise around the X-axis with respect to the horizontal line HL). A viewing target display area TA2 in this case is further reduced while maintaining the aspect ratio compared to the viewing target display area TA1 (depth 1) shown in FIG. 3C. Accordingly, in the entire screen of the display 10, the area of the suppression display RD in the area other than the viewing target display area TA2 (the remaining areas on both sides) is enlarged. Further, in the viewing target display area TA2, a viewing target with a lower contrast is displayed compared to the viewing target display area TA1 (depth 1) shown in FIG. 3C. Accordingly, compared to the display mode at depth 1 shown in FIG. 3C, the suppression display RD is displayed with greater emphasis (higher emphasis).

### Suppression Control: Depth 3, Inclined Downward and Leftward

FIG. 3F is a diagram showing the display content of the display 10 when suppression control is performed (depth 3, inclined downward and leftward). FIG. 3F shows an example in which the vehicle M with the passenger P determined to be at depth 3 is moving straight in the X-axis direction on a road that is inclined downward and leftward (a road that is inclined at an angle θ1 counterclockwise around the X-axis with respect to the horizontal line HL). The viewing target display area TA3 in this case displays the suppression display RD (display of a horizontal line) superimposed on the viewing target as compared with the viewing target display area TA2 (depth 2) shown in FIG. 3E. Accordingly, compared to the display mode at depth 2 shown in FIG. 3E, the suppression display RD is displayed with greater emphasis (higher emphasis).

### Suppression Control: Depth 4

FIG. 3G is a diagram showing the display content (depth 4) of the display 10 when the suppression control is performed. FIG. 3G shows an example in which the vehicle M with the passenger P determined to be at depth 4 is moving straight in the X-axis direction. In this case, the display 10 does not display the viewing target regardless of the inclination of the road, and instead displays an alternative display SD over its entire surface. In the case of the first display 11 for the passenger seat, the alternative display SD may be, for example, a message encouraging the driver to look up and look outside (such as a character string such as “Look outside”). In the case of the second display 12 for the rear seat, the alternative display SD may be, for example, an image of the outside of the front of the vehicle M captured by the camera 50, or a message encouraging the driver to look up and look outside.

### Process Flow

### Entire Process

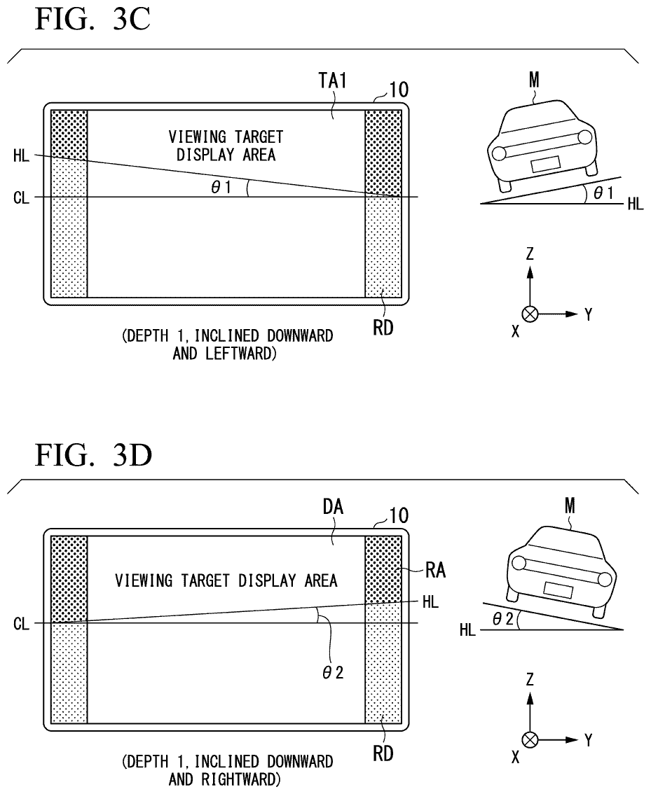

Next, a process of the motion sickness suppression device 1 will be described. FIG. 4 is a flowchart showing an example of a flow of a process of the motion sickness suppression device 1 of the embodiment. The process of this flowchart is repeatedly performed at predetermined time intervals while the vehicle M in which the passenger P is riding is moving.

First, the suppression control unit 102 determines whether or not the passenger P is viewing the content using the display 10 (whether or not the content is being played back) (step S101). For example, the suppression control unit 102 determines whether or not the passenger P is viewing the content on the basis of a signal output from the display 10. When it is determined that the passenger P is not viewing the content (step S101; No), the series of processes in this flowchart ends.

On the other hand, when it is determined that the passenger P is viewing the content (step S101; Yes), the suppression control unit 102 determines whether or not an instruction to change the suppression control has been received from the passenger P via the input interface 20 (step S103). This change instruction includes, for example, a designation of the degree of motion sickness (depth 1 to 4) that the passenger P has self-assessed. The input from the passenger P can be made by operating a touch panel or by voice recognition. In particular, the use of voice recognition can reduce the input burden on passengers suffering from motion sickness.

When it is determined that an instruction to change the suppression control has been received from the passenger P (step S103; Yes), the suppression control unit 102 performs the suppression control according to the depth (step S105). The process of the suppression control according to the depth will be described in detail later.

On the other hand, when it is determined that the instruction to change the suppression control has not been received from the passenger P (step S103; No), the suppression control unit 102 determines whether or not there is information on the passenger state (step S107). The suppression control unit 102 determines whether or not there is information on the passenger state on the basis of, for example, the presence or absence of vital data of the passenger P (heart rate, blood pressure, body temperature, and the like) measured by a wearable device worn by the passenger P, and the presence or absence of an image of the passenger P captured by the interior camera 52.

When it is determined that there is information of the passenger state (step S107; Yes), the suppression control unit 102 detects the passenger state and determines the depth (step S109). The process of detecting the passenger state and determining the depth will be described in detail later.

After the passenger state detection and the depth determination (step S109) are performed, or when it is determined that there is no information on the passenger state (step S107; No), the suppression control unit 102 performs the vehicle state detection and the depth determination (step S111). The process of detecting the vehicle state and determining the depth will be described in detail later. Next, the suppression control unit 102 performs the suppression control according to the determined depth (step S105). As described above, the process of this flowchart ends.

### Suppression Control According to Depth

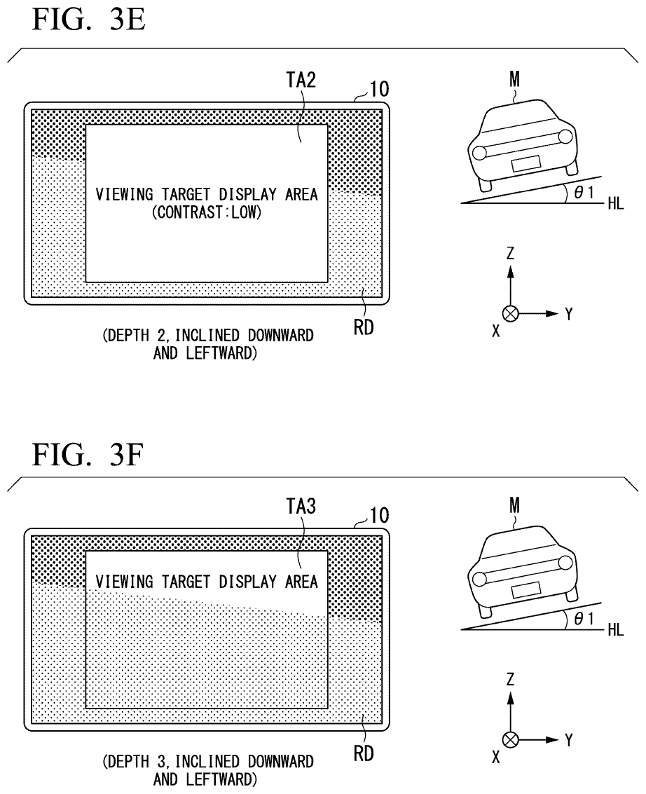

Next, a process of the suppression control according to the depth (step S105) will be described in detail. FIG. 5 is a flowchart showing an example of a flow of a process of the suppression control according to the depth of the embodiment. The suppression control unit 102 performs suppression control according to the depth on the basis of the depth included in the instruction to change suppression control received from the passenger P (step S103), or the depth determined on the basis of the passenger state (step S109) and/or the depth determined on the basis of the vehicle state (step S111). When suppression control is performed according to both the depth determined on the basis of the passenger state (step S109) and the depth determined on the basis of the vehicle state (step S111), the higher (or lower) one of the two depths may be used, the average value of the two depths may be used, or one of the depths set in advance by the passenger P may be used.

First, the suppression control unit 102 determines whether or not the depth is “depth 1” (step S201). When it is determined that the depth is 1 (step S201; Yes), the suppression control unit 102 performs suppression control according to the depth 1 (step S203). The suppression control unit 102 causes the display 10 to display the suppression display RD corresponding to depth 1, as shown in, for example, FIGS. 3B to 3D.

On the other hand, when it is determined that the depth is not “depth 1” (step S201; No), the suppression control unit 102 determines whether or not the depth is “depth 2” (step S205). When it is determined that the depth is 2 (step S205; Yes), the suppression control unit 102 performs suppression control according to depth 2 (step S207). For example, the suppression control unit 102 causes the display 10 to display the suppression display RD corresponding to depth 2 as shown in FIG. 3E.

On the other hand, when it is determined that the depth is not “depth 2” (step S205; No), the suppression control unit 102 determines whether or not the depth is “depth 3” (step S209). When it is determined that the depth is 3 (step S209; Yes), the suppression control unit 102 performs suppression control according to depth 3 (step S211). For example, the suppression control unit 102 causes the display 10 to display the suppression display RD corresponding to depth 3 as shown in FIG. 3F.

On the other hand, when it is determined that the depth is not “depth 3” (step S209; No), the suppression control unit 102 performs suppression control according to depth 4 (step S213). For example, the suppression control unit 102 causes the display 10 to display the alternative display SD corresponding to depth 4 as shown in FIG. 3G.

Next, the suppression control unit 102 displays depth information indicating the currently set depth on the display 10 for a predetermined time (for example, several seconds) to present the information to the passenger P (step S215). Next, the suppression control unit 102 determines whether or not an instruction to change the suppression control (an instruction to change the depth) has been received from the passenger P via the input interface 20 (step S217). For example, when the passenger P determines that there is a deviation between the self-determined degree (depth) of motion sickness and the currently set depth, the passenger P inputs an instruction to change the self-determined depth via the input interface 20. By receiving such a change instruction from the passenger P, it is possible to set the depth (suppression control setting) in accordance with the request of the passenger P.

When it is determined that the instruction to change the suppression control has been received from the passenger P (step S217; Yes), the suppression control unit 102 determines whether or not the instruction is a response to the depth determination based on the passenger state (step S219). For example, when the passenger P issues an instruction to change the depth (step S109) determined on the basis of the passenger state to another depth, the suppression control unit 102 determines that the instruction is a response to the depth determination based on the passenger state. When it is determined that the response is to the depth determination based on the passenger state (step S219; Yes), the resistance information management unit 104 updates the passenger resistance information of the passenger state (step S221). Next, the process returns to step S201, and the suppression control unit 102 performs suppression control according to the changed depth, and repeats the subsequent processes.

On the other hand, when it is determined that the response is not to the depth determination based on the passenger state (step S219; No), the suppression control unit 102 determines whether or not the response is to the depth determination based on the vehicle state (step S223). For example, when the passenger P issues an instruction to change the depth determined on the basis of the vehicle state (step S111) to another depth, the suppression control unit 102 determines that the instruction is a response to the depth determination based on the vehicle state. When it is determined that the response is to the depth determination based on the vehicle state (step S223; Yes), the resistance information management unit 104 updates the passenger resistance information of the traveling state and the environment (step S225). Next, the process returns to step S201, and the suppression control unit 102 performs suppression control according to the changed depth, and repeats the subsequent processes. Further, when it is determined that the response is not to the depth determination based on the vehicle state (step S223; No), the process returns to step S201, and the suppression control unit 102 performs suppression control according to the changed depth, and repeats the subsequent processes. Finally, when it is determined that the instruction to change the suppression control has not been received from the passenger P (step S217; No), the process of this flowchart ends.

### Passenger State Detection and Depth Determination

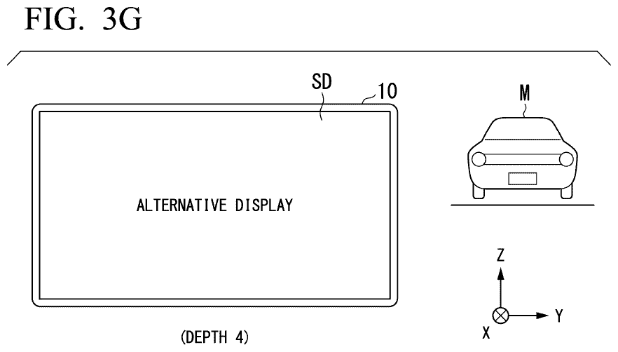

Next, a process of detecting the passenger state and determining the depth (step S109) will be described in detail. FIG. 6 is a flowchart showing an example of a flow of a process of detecting the passenger state and determining the depth of the embodiment.

First, the sickness determination unit 103 determines whether or not the management server 3 or the storage unit 200 contains passenger resistance information (a learned value of the sickness resistance of the passenger P) associated with the passenger P (step S301). When it is determined that the passenger resistance information is available (step S301; Yes), the sickness determination unit 103 reads the passenger resistance information (step S303). On the other hand, when it is determined that there is no passenger resistance information (step S301; No), the sickness determination unit 103 reads standard resistance information from the management server 3 or the storage unit 200 (step S313).

Next, the sickness determination unit 103 determines whether or not the passenger P has just got into the vehicle M (riding time≤threshold) (step S305). When it is determined that the passenger P has just got into the vehicle M (step S305; Yes), the sickness determination unit 103 detects the normal passenger state (heart rate, respiratory rate, upper limb/head movements, eye movements, blinking, and the like) of the passenger P on the basis of the detection value of the wearable device worn by the passenger P and the image of the passenger P captured by the interior camera 52 (step S307).

Next, the sickness determination unit 103 detects the passenger state (heart rate, respiratory rate, upper limb/head movement, eye movement, blinking, and the like) of the passenger P while the vehicle M is traveling (riding time>threshold) on the basis of the detection value of the wearable device worn by the passenger P and the image of the passenger P captured by the interior camera 52 (step S309).

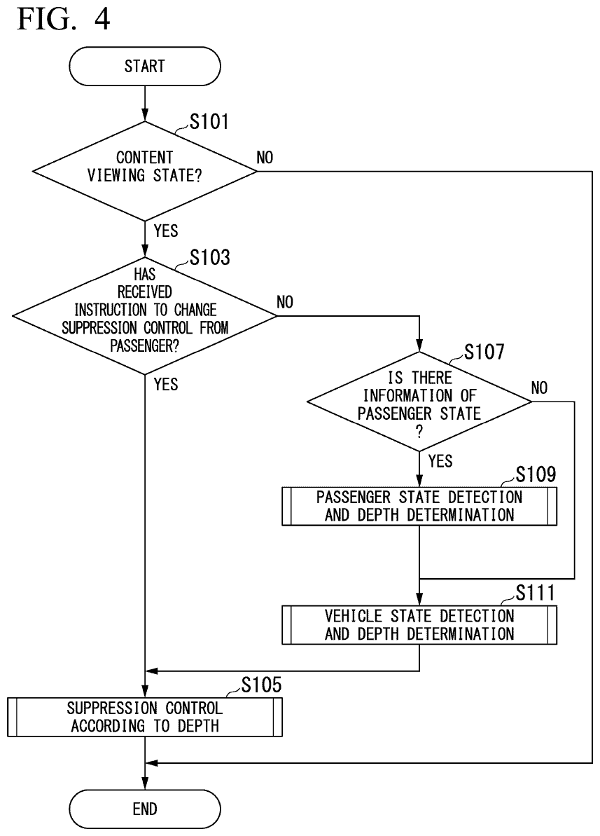

Next, the sickness determination unit 103 determines the recommended sickness depth on the basis of the change in the passenger state (step S311). When the passenger resistance information of the passenger P is read in step S303, the sickness determination unit 103 determines the depth on the basis of the passenger resistance information, the normal passenger state, and the passenger state while traveling. FIG. 7 is a diagram showing passenger resistance information (resistance map of the passenger P) of the passenger state associated with the passenger P of the embodiment. In the passenger resistance information of the passenger state, the horizontal axis represents the change in heart rate (the difference between the normal heart rate and the heart rate while traveling), and the vertical axis represents the change in head movement amount (the difference between the normal head movement amount and the heart rate while traveling). The sickness determination unit 103 calculates the difference between the normal passenger state of the passenger P detected in step S307 and the passenger state of the passenger P while traveling detected in step S309 as a state change (a change in heart rate, a change in head movement amount). Then, the sickness determination unit 103 determines the depth by mapping the calculated state changes (a change in heart rate, a change in head movement amount) onto passenger resistance information of the passenger state (resistance map of passenger P).

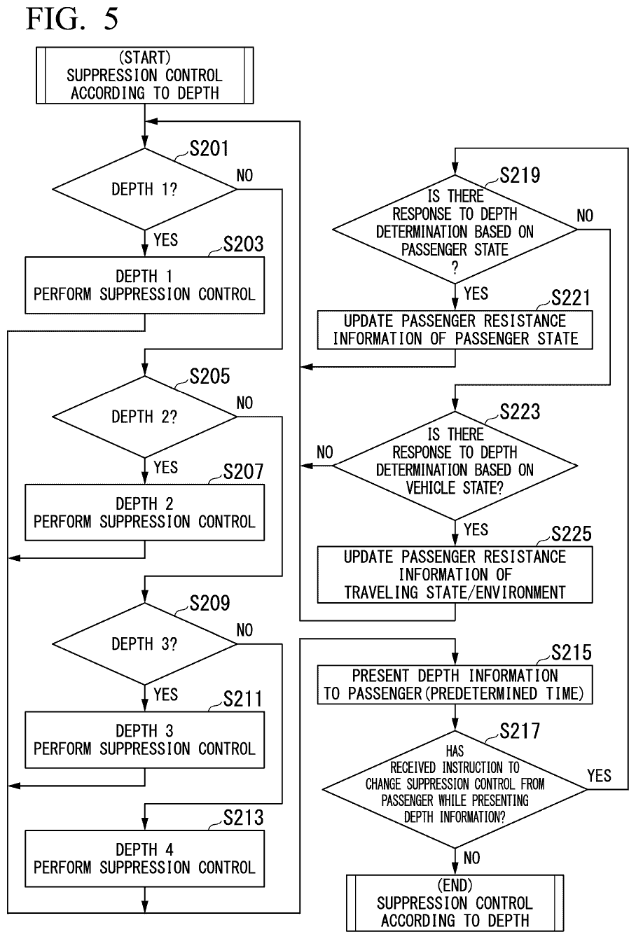

On the other hand, when the standard resistance information (standard resistance map) is read in step S313 (when the passenger resistance information of the passenger P is not read), the sickness determination unit 103 determines the depth on the basis of the standard resistance information (standard resistance map), the normal passenger state, and the passenger state while traveling. FIG. 8 is a diagram showing the standard resistance information (standard resistance map) of the passenger state of the embodiment. In the standard resistance information, the horizontal axis represents the change in heart rate (the difference between the normal heart rate and the heart rate while traveling), and the vertical axis represents the change in head movement amount (the difference between the normal head movement amount and the heart rate while traveling). The sickness determination unit 103 calculates the difference between the normal passenger state of the passenger P (heart rate, head movement amount) detected in step S307 and the passenger state (heart rate, head movement amount) of the passenger P while traveling detected in step S309 as a state change (a change in heart rate, a change in head movement amount). Then, the sickness determination unit 103 determines the depth by mapping the calculated state changes (changes in heart rate and head movement amount) to standard resistance information (standard resistance map). As described above, the process of this flowchart ends.

### Vehicle State Detection and Depth Determination

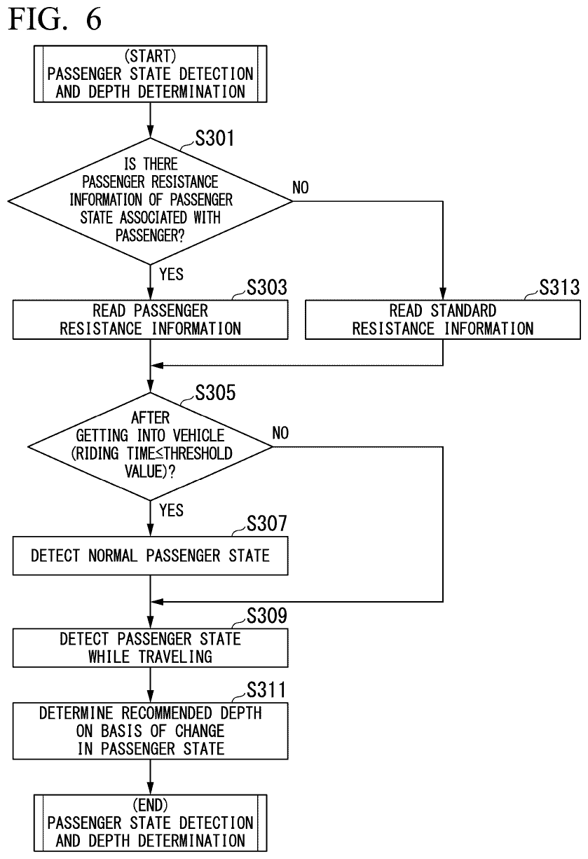

Next, a process of detecting the vehicle state and determining the depth (step S111) will be described in detail. FIG. 9 is a flowchart showing an example of a flow of a process of detecting the vehicle state and determining the depth of the embodiment.

First, the sickness determination unit 103 determines whether or not there is passenger resistance information of the vehicle state associated with the passenger P in the management server 3 or the storage unit 200 (step S401). When it is determined that the passenger resistance information is available (step S401; Yes), the sickness determination unit 103 reads the passenger resistance information from the management server 3 or the storage unit 200 (step S403). On the other hand, when it is determined that there is no passenger resistance information (step S401; No), the sickness determination unit 103 reads standard resistance information from the management server 3 or the storage unit 200 (step S415).

Next, the sickness determination unit 103 detects the behavior of the vehicle over a certain period of time and calculates the accumulated lateral and vertical values(accumulated lateral G, accumulated vertical G) of gravitational acceleration equal to or larger than a predetermined gravitational acceleration (predetermined G) (step S405).

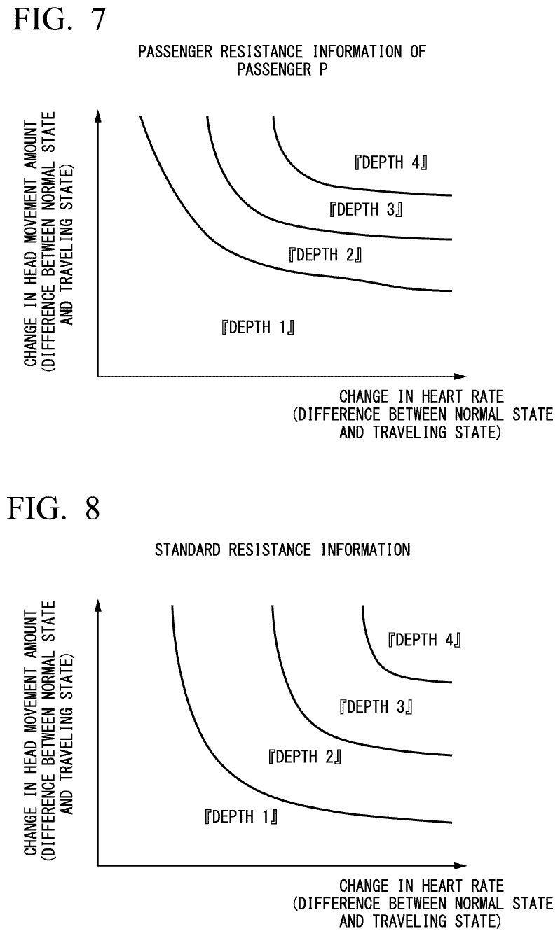

Next, the sickness determination unit 103 determines a recommended depth (first depth) on the basis of the calculated accumulated lateral G and accumulated vertical G (step S407). When the passenger resistance information of the passenger P is read in step S403, the sickness determination unit 103 determines the first depth on the basis of the passenger resistance information and the calculated accumulated lateral G and accumulated vertical G. FIG. 10 is a diagram showing the passenger resistance information (resistance map of passenger P) of the vehicle state associated with the passenger P of the embodiment. In this passenger resistance information, the horizontal axis represents accumulated lateral G, and the vertical axis represents accumulated vertical G. The sickness determination unit 103 determines the first depth by mapping the accumulated G (accumulated lateral G, accumulated vertical G) calculated in step S405 to the passenger resistance information (resistance map of the passenger P).

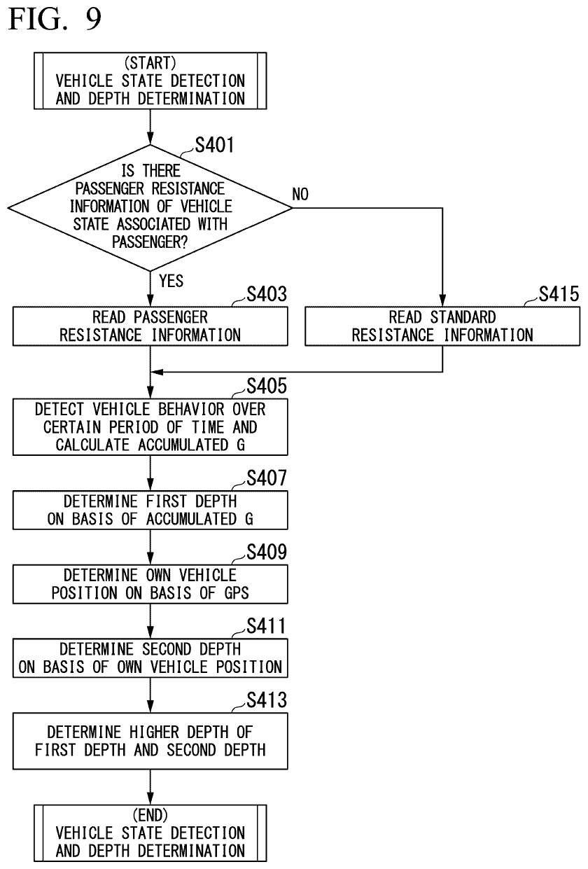

On the other hand, when the standard resistance information is read in step S415 (when the passenger resistance information of the passenger P is not read), the sickness determination unit 103 determines the depth (first depth) on the basis of the standard resistance information and the calculated accumulated G. FIG. 11 is a diagram showing the standard resistance information (standard resistance map) related to the vehicle state of the embodiment. In this standard resistance information, the horizontal axis is accumulated horizontal G and the vertical axis is accumulated vertical G. The sickness determination unit 103 determines the first depth by mapping the accumulated G (accumulated lateral G, accumulated vertical G) calculated in step S405 onto standard resistance information (standard resistance map).

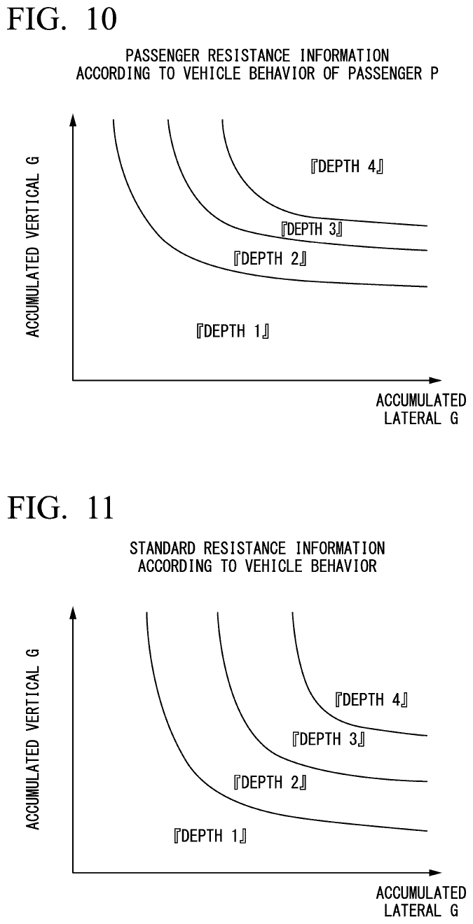

Next, the sickness determination unit 103 determines the own vehicle position of the vehicle M on the basis of the GPS (longitude and latitude information) acquired by the position sensor (step S409). Next, the sickness determination unit 103 determines a recommended depth (second depth) on the basis of the determined own vehicle position (step S411). When the passenger resistance information of the passenger P is read in step S403, the sickness determination unit 103 determines the depth on the basis of the passenger resistance information and the determined own vehicle position. FIG. 12 is a diagram showing the passenger resistance information according to the vehicle position associated with the passenger P of the embodiment. In this passenger resistance information, the own vehicle position environment (mountain pass road (strong), mountain pass road (weak), etc.) is associated with the depth state. The sickness determination unit 103 determines the own vehicle position environment corresponding to the determined own vehicle position on the basis of the map information stored in the storage unit 200, and determines the depth associated with the own vehicle position environment in the passenger resistance information as the second depth.

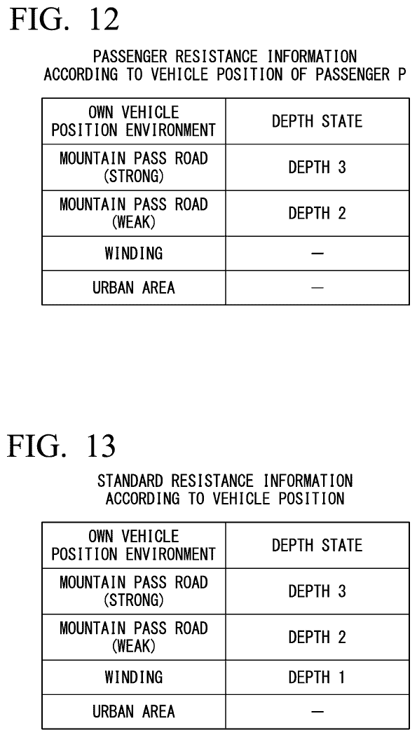

When the standard resistance information is read in step S415 (when the passenger resistance information of the passenger P is not read), the sickness determination unit 103 determines the depth (second depth) on the basis of the standard resistance information and the determined own vehicle position. FIG. 13 is a diagram showing the standard resistance information according to the vehicle position of the embodiment. In this standard resistance information, the own vehicle position environment (mountain pass road (strong), mountain pass road (weak), etc.) is associated with the depth state. The sickness determination unit 103 determines the own vehicle position environment corresponding to the determined own vehicle position on the basis of the map information stored in the storage unit 200, and determines the depth associated with the own vehicle position environment in the standard resistance information as the second depth.

Next, the sickness determination unit 103 determines the higher one of the first depth and the second depth as the final recommended depth (step S413). As described above, the process of this flowchart ends.

According to the above-described embodiment, it is possible to achieve both a good viewing experience and motion sickness suppression while riding in the conveyance by switching the mode of the suppression display according to the degree of motion sickness of the passenger.

Although the mode for carrying out the present invention has been described using an embodiment, the present invention is not limited to such an embodiment, and various modifications and substitutions can be made within the scope that does not deviate from the gist of the present invention. Accordingly, priority can be given to the viewing experience when motion sickness is slight, or to improvement of the passenger's motion sickness when motion sickness becomes worse.

What is claimed is:

1. A motion sickness suppression device comprising:
a sickness determination unit which determines a degree of motion sickness of a passenger viewing a viewing target displayed on a display device in a conveyance; and
a suppression control unit which switches a mode of suppression display for suppressing motion sickness according to the determined degree of motion sickness and displays the mode on the display device.

2. The motion sickness suppression device according to claim 1,
wherein the sickness determination unit determines the degree of motion sickness on the basis of a passenger state.

3. The motion sickness suppression device according to claim 2,
wherein the sickness determination unit determines the degree of motion sickness on the basis of vital data of the passenger detected by a sensor.

4. The motion sickness suppression device according to claim 2,
wherein the sickness determination unit determines the degree of motion sickness on the basis of image data of the passenger captured by an imaging device.

5. The motion sickness suppression device according to claim 1,
wherein the sickness determination unit determines the degree of motion sickness on the basis of an input instruction by the passenger.

6. The motion sickness suppression device according to claim 1,
wherein the sickness determination unit determines the degree of motion sickness on the basis of behavior of the conveyance within a predetermined time period in the past or a location of the conveyance.

7. The motion sickness suppression device according to claim 1,
wherein the sickness determination unit determines the degree of motion sickness on the basis of information on resistance of the passenger to the motion sickness.

8. The motion sickness suppression device according to claim 7, further comprising:
a resistance information management unit which updates the resistance information on the basis of a change history of the degree of motion sickness changed according to an input instruction by the passenger.

9. The motion sickness suppression device according to claim 1,
wherein the suppression display is a horizontal line.

10. The motion sickness suppression device according to claim 1,
wherein the suppression control unit controls the display of the display device so that the suppression display becomes emphasized as the determined degree of motion sickness becomes worse.

11. The motion sickness suppression device according to claim 10,
wherein the suppression control unit controls the display of the display device so that a viewing target display area in the display device is reduced and a display area of the suppression display is enlarged as the determined degree of motion sickness becomes worse.

12. The motion sickness suppression device according to claim 10,
wherein the suppression control unit controls the display of the display device so that a contrast of a display of the viewing target in the display device decreases as the determined degree of motion sickness becomes worse.

13. A motion sickness suppression method of causing a computer to:
determine a degree of motion sickness of a passenger viewing a viewing target displayed on a display device in a conveyance; and
switch a mode of suppression display for suppressing motion sickness according to the determined degree of motion sickness and display the mode on the display device.

14. A computer-readable non-transitory storage medium for storing a program causing a computer to:
determine a degree of motion sickness of a passenger viewing a viewing target displayed on a display device in a conveyance; and
switch a mode of suppression display for suppressing motion sickness according to the determined degree of motion sickness and display the mode on the display device.
